(19) United States
(12) Patent Application Publication
(10) Pub. No.: US 2026/0200456 A1
(43) Pub. Date: Jul. 16, 2026

(54) PARKING BRAKE RELEASE APPARATUS AND METHOD FOR A DOUBLE-PARKED VEHICLE

(71) Applicants: HYUNDAI MOTOR COMPANY, Seoul (KR); KIA CORPORATION, Seoul (KR)

(72) Inventors: Jungmo Yu, Hwaseong-si (KR); Jeawan Kim, Hwaseong-si (KR)

(73) Assignees: HYUNDAI MOTOR COMPANY, Seoul (KR); KIA CORPORATION, Seoul (KR)

(21) Appl. No.: 19/320,457

(22) Filed: Sep. 5, 2025

(30) Foreign Application Priority Data
Jan. 13, 2025 (KR) 10-2025-0004753

(51) Int. Cl. B60W 10/18; B60W 10/20

(52) U.S. Cl. CPC B60W 10/182; B60W 10/20; B60W 2510/20; B60W 2520/10; B60W 2554/00; B60W 2555/00; B60W 2710/186

(57) ABSTRACT

A parking brake release method may include: receiving a request for a parking brake release of a vehicle; determining whether the parking brake release is permitted; requesting an owner of thing vehicle for a final approval of the parking brake release when the parking brake release is determined to be permitted; and remotely releasing the parking brake of the vehicle when the final approval of the owner is received.

### CROSS-REFERENCE TO RELATED APPLICATION

This application claims priority to and the benefit of Korean Patent Application No. 10-2025-0004753 filed with the Korean Intellectual Property Office on Jan. 13, 2025, the entire contents of which are incorporated herein by reference.

### TECHNICAL FIELD

The present disclosure relates to a parking brake release apparatus and method for a double-parked vehicle. More particularly, the present disclosure relates to a parking brake release apparatus and method for a double-parked vehicle for alleviating the inconvenience of double parking.

### BACKGROUND

Recently, the lack of parking space has become a significant problem in apartments and villas without an underground parking lot. In such cases, double parking may be unavoidable, but engaging the parking brake at double parking makes it impossible to move the vehicle in an emergency, causing inconvenience to the owners of other vehicles.

If there is a need to use a vehicle for an urgent matter and there is a double-parked vehicle that is not movable, the contact with the owner of the vehicle through the vehicle number is attempted, through which the owner may not be reached in some cases. After repeated attempts to contact the owner, there are cases where the owner is out, thereby unable to move the vehicle immediately, or the contact is lost.

A server-based parking brake release system of a double-parked vehicle may provide convenience, but it needs to be carefully considered for various aspects such as a safety problem or a security problem.

The statements in this Background section merely provide background information related to the present disclosure and may not constitute prior art.

### SUMMARY

The present disclosure provides a parking brake release apparatus and method for a double-parked vehicle capable of determining whether a parking brake release is permitted in response to a request for a parking brake release with respect to a parked vehicle of a user, and remotely releasing the parking brake of the parked vehicle based on the final approval of the owner of the parked vehicle.

A parking brake release method may include: receiving a request for a parking brake release of a parked vehicle; determining whether the parking brake release is permitted; requesting an owner of thing parked vehicle for a final approval of the parking brake release when the parking brake release is determined to be permitted or based on the parking brake release being determined to be permitted; and remotely releasing the parking brake of the parked vehicle when the final approval of the owner is received or based on a receipt of the final approval of the owner.

The parking brake release method may further include determining whether the parked vehicle is prepared for moving when the parking brake is released or based on the parking brake being released. Determining whether the parked vehicle is prepared for moving may include: determining a tire direction of the parked vehicle; determining a side mirror position of the parked vehicle; and determining whether there exists obstacle in a moving direction of the parked vehicle.

The parking brake release method may further include controlling the vehicle based on a sensor before moving of the parked vehicle when or based on a condition that whether the parked vehicle is prepared for moving is not confirmed. Controlling the vehicle based on the sensor before moving of the parked vehicle may include: adjusting the tire direction to be straight by using a steering angle sensor; folding an unfolded side mirror; providing an external warning until the obstacle is not detected; and lighting a hazard light when confirmed to be prepared for moving or based on confirmation that the vehicle is prepared for moving.

The parking brake release method may further include controlling the parked vehicle based on the sensor during moving of the parked vehicle when whether the parked vehicle is prepared for moving is confirmed or based on a condition that whether the vehicle is prepared for moving is confirmed., Controlling the vehicle based on the sensor during moving of the parked vehicle may include: operating the parking brake again when an obstacle is detected within reference radius during the movement of the parked vehicle or based on the obstacle being detected within a reference radius during movement of the vehicle; operating the parking brake again when vehicle speed of the parked vehicle becomes higher than a predetermined speed during the movement of the parked vehicle or based on a vehicle speed of the vehicle being higher than a predetermined speed during the movement of the vehicle; and operating the parking brake again when a predetermined time has elapsed or the parked vehicle has moved by a predetermined distance during the movement of the parked vehicle or based on a predetermined time having elapsed or the vehicle having moved by a predetermined distance during the movement of the vehicle.

Receiving the parking brake release request may include: collecting vehicle information of the parked vehicle based on a vehicle number when the vehicle number of the parked vehicle is input through an application of a user terminal; specifying the owner of the parked vehicle based on the vehicle information; and providing a notification on a request for the parking brake release to a terminal of the owner.

Determining whether the parking brake release is permitted may include: determining whether the parked vehicle is turned off; determining whether all doors are locked up; determining whether the parking brake is in a predetermined state; and determining whether there is no person inside the vehicle.

Determining whether the parking brake release is permitted may further include: determining whether the parked vehicle is parked on a flat surface or a sloped surface by using a tilt sensor attached to the parked vehicle; and determining that the parking brake release is not permitted, when it is determined that the parked vehicle is parked on the sloped surface or based on a determination that the vehicle is parked on the sloped surface.

The determining whether the parking brake release is permitted may further include: determining whether a parked position of the parked vehicle is in a double parking area of a parking lot; detecting a person or an object within a predetermined range of surroundings of the parked vehicle; and determining that the parking brake release is permitted when the parked position is in a double parking area and the person or object is not detected within the predetermined range of surroundings or based on the parked position being in a double parking area and the person or the object being not detected within the predetermined range of surroundings.

Remotely releasing the parking brake of the parked vehicle when the final approval of the owner is received or based on the receipt of the final approval of the owner may include: voluntarily releasing the parking brake even before the final approval of the owner is received; and transmitting an alarm with respect to the voluntary release of the parking brake to the owner when one or more requests for the parking brake release exceeds a reference value based on one or more requests for the parking brake release exceeding a reference value.

The parking brake release method may further include operating the parking brake of the parked vehicle again, when the parked vehicle has not moved for a preset time or more after the parking brake release of the parked vehicle, or when an input of the termination of the reason for releasing the parking brake is received from the owner or based on the vehicle having not moved for a preset time or more after the parking brake release of the vehicle, or an input of a termination of a reason for releasing the parking brake being received from the owner; and providing a notification for the termination of the reason for releasing the parking brake.

An apparatus for remotely releasing a parking brake of a double-parked vehicle according to a user request may include: one or more memory devices storing program codes; and one or more processors configured to perform, by execute the program, receiving a request for a parking brake release of a parked vehicle, determining whether the parking brake release is permitted, requesting an owner of the parked vehicle for a final approval of the parking brake release when the parking brake release is determined to be permitted or based on the parking brake release being determined to be permitted, and remotely releasing the parking brake of the parked vehicle when the final approval of the owner is received or based on a receipt of the final approval of the owner.

The one or more processors is further configured to perform determining whether the parked vehicle is prepared for moving when the parking brake is released or based on the parking brake being released. Determining whether the parked vehicle is prepared for moving may include: determining a tire direction of the parked vehicle; determining a side mirror position of the parked vehicle; and determining whether there exists obstacle in a moving direction of the parked vehicle.

The one or more processors is further configured to perform controlling the vehicle based on a sensor before moving of the parked vehicle when whether the parked vehicle is prepared for moving is not confirmed or based on a condition that whether the vehicle is prepared for moving is not confirmed. Controlling the vehicle based on the sensor before moving of the parked vehicle may include: adjusting the tire direction to be straight by using a steering angle sensor; folding an unfolded side mirror; providing an external warning until the obstacle is not detected; and lighting a hazard light when confirmed to be prepared for moving or based on confirmation that the vehicle is prepared for moving.

The wherein the one or more processors is further configured to perform controlling the parked vehicle based on the sensor during moving of the parked vehicle when whether the parked vehicle is prepared for moving is confirmed or based on a condition that whether the vehicle is prepared for moving is confirmed. Controlling the vehicle based on the sensor during moving of the parked vehicle may include: operating the parking brake again when an obstacle is detected within a reference radius during the movement of the parked vehicle or based on the obstacle being detected within a reference radius during movement of the vehicle; operating the parking brake again when a vehicle speed of the parked vehicle becomes higher than a predetermined speed during the movement of the parked vehicle or based on a vehicle speed of the vehicle being higher than a predetermined speed during the movement of the vehicle; and operating the parking brake again when a predetermined time has elapsed or the parked vehicle has moved by a predetermined distance during the movement of the parked vehicle or based on a predetermined time having elapsed or the vehicle having moved by a predetermined distance during the movement of the vehicle.

Receiving the parking brake release request may include: collecting vehicle information of the parked vehicle based on a vehicle number when the vehicle number of the parked vehicle is input through an application of a user terminal or based on a vehicle number of the vehicle being input through an application of a user terminal; specifying the owner of the parked vehicle based on the vehicle information; and providing a notification on a request for the parking brake release to a terminal of the owner.

Determining whether the parking brake release is permitted may include: determining whether the parked vehicle is turned off; determining whether all doors are locked up; determining whether the parking brake is in a predetermined state; and determining whether there is no person inside the vehicle.

Determining whether the parking brake release is permitted may further include: determining whether the parked vehicle is parked on a flat surface or a sloped surface by using a tilt sensor attached to the parked vehicle; and determining that the parking brake release is not permitted when it is determined that the parked vehicle is parked on the sloped surface or based on a determination that the vehicle is parked on the sloped surface.

Determining whether the parking brake release is permitted may further include: determining whether a parked position of the parked vehicle is in a double parking area of a parking lot by using a GPS, a camera, a radar, a lidar or an ultrasonic wave sensor attached to the parked vehicle; sensing a person or an object within a predetermined range of surroundings of the parked vehicle by using the camera, the radar, the lidar or the ultrasonic wave sensor; and determining that the parking brake release is permitted when the parked position is in a double parking area and the person or object is not detected within the predetermined range of surroundings based on the parked position being in a double parking area and the person or the object being not detected within the predetermined range of surroundings.

Remotely releasing the parking brake of the parked vehicle when the final approval of the owner is received or based on the receipt of the final approval of the owner may include: voluntarily releasing the parking brake even before the final approval of the owner is received; and transmitting an alarm with respect to the voluntary release of the parking brake to the owner when one or more requests for the parking brake release exceeds a reference value or based on one or more requests for the parking brake release exceeding a reference value.

The one or more processors is further configured to perform: operating the parking brake of the parked vehicle again when the parked vehicle has not moved for a designated predetermined time or more after the parking brake release, or when an input of a termination of a reason for releasing the parking brake is received from the owner or based on the vehicle having not moved for a preset time or more after the parking brake release of the vehicle, or an input of a termination of a reason for releasing the parking brake being received from the owner; and providing a notification for the termination of the reason for releasing the parking brake to the owner and the outside.

According to a parking brake release apparatus and method for a double-parked vehicle according to an embodiment, the parking brake of the parked vehicle is released under the final approval of the owner only when the parking brake release is permitted, thereby being safer and more advantageous for security.

### BRIEF DESCRIPTION OF THE DRAWINGS

FIG. 1 schematically shows a parking brake release system of the parked vehicle according to an embodiment.

FIG. 2 is a block diagram of a double-parking brake release apparatus of the parked vehicle according to an embodiment.

FIG. 3 and FIG. 4 are flowcharts of a parking brake release method of the parked vehicle according to an embodiment.

FIG. 5A and FIG. 5B are flowcharts of a parking brake release method of the parked vehicle according to an embodiment.

FIG. 6 is a signal flowchart of a parking brake release system of the parked vehicle according to an embodiment.

FIG. 7 is a drawing for explaining a computing device according to an embodiment.

The drawings described herein are for illustration purposes only and are not intended to limit the scope of the present disclosure in any way.

### DETAILED DESCRIPTION

An embodiment of the disclosure is described more fully hereinafter with reference to the accompanying drawings such that a person having ordinary skill in the art may easily implement the embodiment. As those having ordinary skill in the art would realize, the described embodiments may be modified in various different ways, all without departing from the spirit or scope of the present disclosure. In order to clarify the present disclosure, parts that are not related to the description have been omitted, and the same elements or equivalents are referred to with the same reference numerals throughout the specification.

In addition, unless explicitly described to the contrary, the terms such as “comprise,” “include” and the like and variations such as “comprises,” “comprising,” “includes”, “including” and the like should be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software. When a component, processor, controller, device, element, apparatus, or the like of the present disclosure is described as having a purpose or performing an operation, function, or the like, the component, processor, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

Hereinafter, embodiments of the present disclosure are described with reference to the drawings.

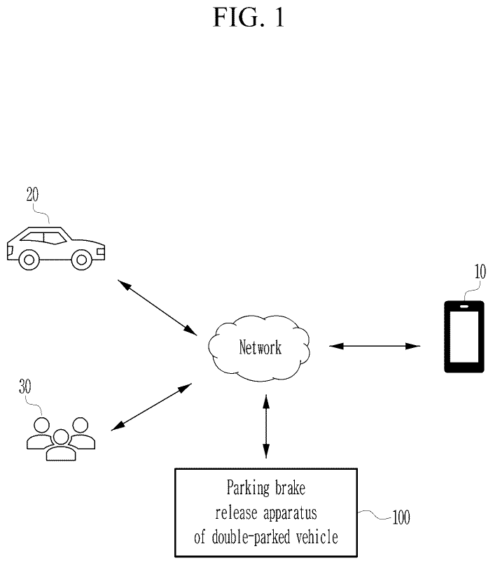

FIG. 1 schematically shows a parking brake release system of a parked vehicle according to an embodiment.

Referring to FIG. 1, the parking brake release system of the parked vehicle may include a vehicle owner terminal 10, a parked vehicle 20, a requester 30 and a parking brake release apparatus 100 of a double-parked vehicle.

The vehicle owner terminal 10, the parked vehicle 20, the requester 30 and the parking brake release apparatus 100 of a double-parked vehicle may communicate with each other through a wired/wireless network.

The vehicle owner terminal 10 may include digital devices such as a PC, a mobile phone, a tablet, or the like of a vehicle owner.

The vehicle owner terminal 10 may receive the parking brake release request of the requester 30 and provide a notification to the vehicle owner.

The vehicle owner may input a final approval of the parking brake release by using an application or the like of the vehicle owner terminal 10.

The vehicle owner may perform various controls including the parking brake release with respect to the parked vehicle 20 through the application of the vehicle owner terminal 10.

The parked vehicle 20 may be the vehicle of the double-parked vehicle owner with the parking brake engaged. The parked vehicle 20 exchanges signals with the vehicle owner terminal 10 and the parking brake release apparatus 100 of a double-parked vehicle through a network.

The vehicle type and vehicle shape of the parked vehicle 20 are not particularly limited. For example, the parked vehicle 20 may include various forms of transportation such as a PBV (purpose-built vehicle) mobility device.

The requester 30 may include a requester terminal. The requester 30 may include a plurality of requester terminals. The requester 30 may request the parking brake release of the parked vehicle 20.

The requester 30 may transmit the parking brake release request to the parking brake release apparatus 100 of a double-parked vehicle by using an application installed in the requester terminal.

The parking brake release apparatus 100 of a double-parked vehicle may also be applied to an autonomous mobile vehicle, and in the case of the autonomous mobile vehicle, the requester 30 and the requester terminal may be a requester and the requester terminal or server.

When a release request of the parking brake with respect to the double-parked vehicle 20 is received from the requester 30, the parking brake release apparatus 100 of a double-parked vehicle may determine whether the vehicle parking brake release of the parked vehicle 20 is permitted, and when the parking brake release final approval is received from the vehicle owner terminal 10, may transmit the parking brake release request to the vehicle owner terminal 10 when whether the release is permitted is determined, and release the parking brake through the control of the parked vehicle 20 and notify it to the requester 30.

The parking brake release apparatus 100 of a double-parked vehicle may engage the parking brake again after a movement of the parked vehicle 20 is completed.

The parking brake release apparatus 100 of a double-parked vehicle performs releasing of the parking brake of the vehicle, in consideration of communication security problems between the vehicle owner and the requester and safety problems in the parked vehicle and surrounding environments.

In other words, the parking brake release apparatus 100 of a double-parked vehicle may determine a release possibility of the parking brake of the parked vehicle 20 for better security, check whether the parking brake release is permitted via the vehicle owner terminal 10 for better security, and automatically engage the parking brake again under a preset condition including completion of the vehicle movement after releasing the parking brake.

In addition, the parking brake release apparatus 100 of a double-parked vehicle may perform various controls of the vehicle for safe movement of the vehicle even after releasing the parking brake under the final approval of the vehicle owner.

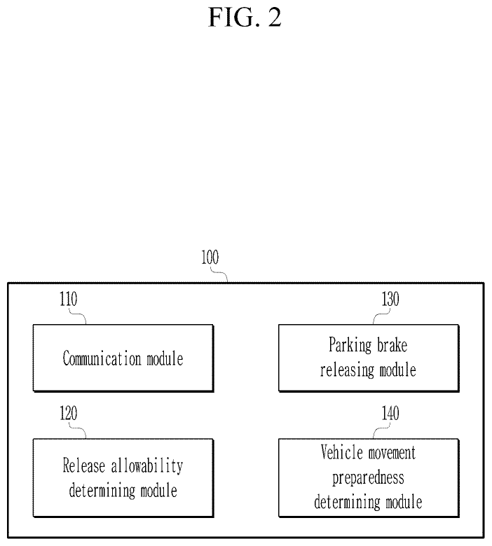

FIG. 2 is a block diagram of a parking brake release apparatus of the double-parked vehicle according to an embodiment.

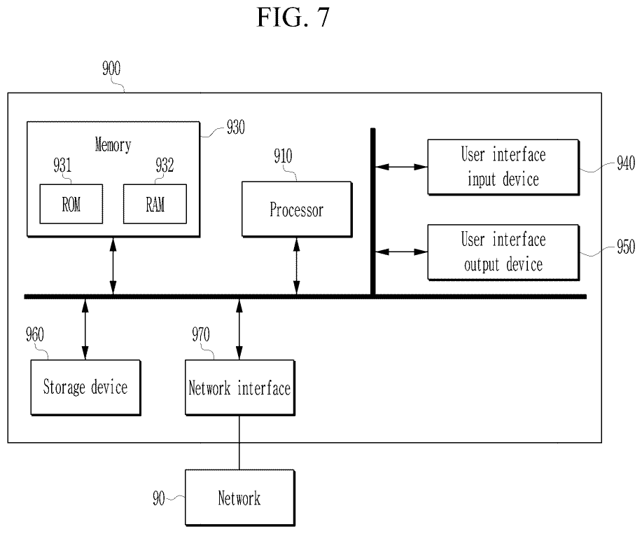

Referring to FIG. 2, the parking brake release apparatus 100 of a double-parked vehicle according to an embodiment may execute program codes or instructions loaded on one or more memory devices through one or more processors. For example, the parking brake release apparatus 100 of a double-parked vehicle may be implemented as a computing device 900, as described below in connection with FIG. 7.

In this case, the one or more processors may correspond to a processor 910 of the computing device 900, and the one or more memory devices may correspond to a memory 930 of the computing device 900.

The program codes or instructions may be executed by the one or more processors, and may remotely release the parking brake of the double-parked vehicle according to a user's request. In this disclosure, the term “module” is used to logically differentiate functions performed by the program code or instruction.

Referring to FIG. 2, the parking brake release apparatus 100 of a double-parked vehicle may include a communication module 110, a release allowability determining module 120, a parking brake releasing module 130 and a vehicle movement preparedness determining module 140.

The communication module 110 may receive a request for the parking brake release with respect to the parked vehicle from the requester 30 (see FIG. 1), and request the approval of the parking brake release from the vehicle owner terminal 10 (see FIG. 1).

In other words, the communication module 110 may exchange signals not only with the parked vehicle 20 (see FIG. 1) but also with the requester terminal and the vehicle owner terminal.

When a number of the parked vehicles is input through the application of the requester terminal 30 of the requester at the time of receiving the request for the parking brake release with respect to the parked vehicle, the communication module 110 may collect vehicle information of the parked vehicle based on the input vehicle number.

The communication module 110 may specify the owner of the parked vehicle based on the vehicle information and provide a notification for the request for the parking brake release to the vehicle owner terminal.

The release allowability determining module 120 may determine whether the parking brake release of the parked vehicle is permitted. For example, the parking brake release of the parked vehicle may be permitted when there is no condition (e.g., predetermined condition) prohibiting the release of the parking brake of the parked vehicle.

The release allowability determining module 120 may check whether the parked vehicle is turned off, whether all doors are locked up and whether the parking brake is in a predetermined state and whether there is no person inside the vehicle.

The release allowability determining module 120 may determine whether the parked vehicle is parked on a flat surface or a sloped surface by using a tilt sensor attached to the parked vehicle.

The release allowability determining module 120 may determine that the parking brake release is not permitted when it is determined that the parked vehicle is parked on sloped surface.

The release allowability determining module 120 may check whether a parked position of the parked vehicle is in a double parking area of a parking lot by using a GPS (global positioning system), a camera, a radar, a lidar or an ultrasonic wave sensor attached to the parked vehicle.

The release allowability determining module 120 may sense a person or object within a certain range of surroundings of the parked vehicle by using a camera, a radar, a lidar or an ultrasonic wave sensor.

When the parked position is in a double parking area and a person or object is not detected within a certain range of surroundings, the release allowability determining module 120 may determine that the parking brake release is permitted.

The parking brake releasing module 130 may remotely release the parking brake of the parked vehicle 20 when it is determined that the parking brake release is permitted and the final approval of the parking brake release is received from the vehicle owner terminal 10.

When the request for the parking brake release exceeds a reference amount (i.e., a reference value), the parking brake releasing module 130 may voluntarily release the parking brake even before the final approval of the owner is received and transmit an alarm with respect to the voluntary release of the parking brake to owner.

The vehicle movement preparedness determining module 140 may check whether the parked vehicle is prepared for moving when the parking brake is released.

The vehicle movement preparedness determining module 140 may check a tire direction of the parked vehicle, check a side mirror position, and check whether there exists an obstacle in a moving direction of the parked vehicle.

When whether the parked vehicle is prepared for moving is not confirmed, the vehicle movement preparedness determining module 140 may control the vehicle based on sensors before moving the parked vehicle.

The vehicle movement preparedness determining module 140 may adjust the tire direction to be straight by using a steering angle sensor, fold an unfolded side mirror, provide an external warning until the obstacle is not detected.

The vehicle movement preparedness determining module 140 may light a hazard light when confirmed to be prepared for moving.

The parking brake releasing module 130 may control the parked vehicle based on a sensor during moving of the vehicle.

The parking brake releasing module 130 may operate the parking brake again when the obstacle is detected within a reference radius during the movement of the parked vehicle.

The parking brake releasing module 130 may operate the parking brake again when vehicle speed of the parked vehicle becomes higher than particular speed during the movement of the parked vehicle.

The parking brake releasing module 130 may operate the parking brake again when a predetermined particular time has elapsed or the parked vehicle has moved by a predetermined particular distance during the movement of the parked vehicle.

When the parked vehicle has not moved for a designated predetermined time or more after the parking brake release, or when an input of a termination of a reason for releasing the parking brake is received from the owner, the parking brake releasing module 130 may operate the parking brake of the parked vehicle again and provide a notification on the termination of the reason for releasing the parking brake the owner and the outside.

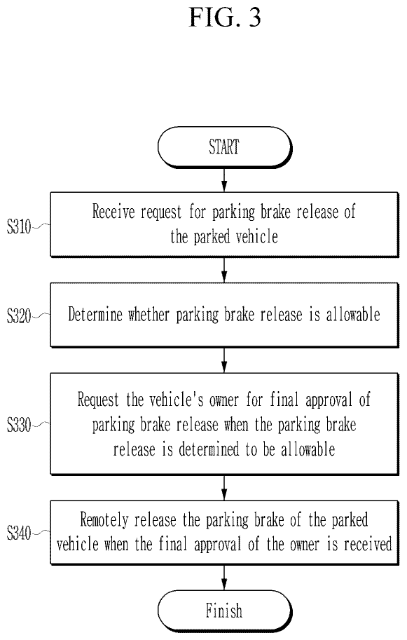

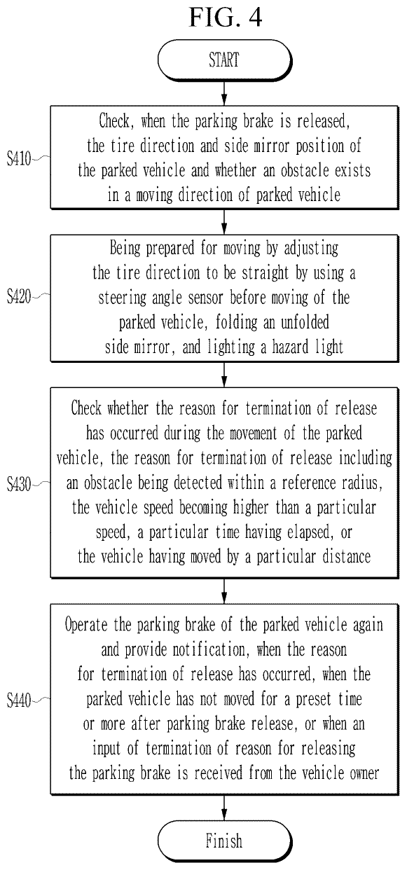

FIG. 3 and FIG. 4 are flowcharts of a parking brake release method of the parked vehicle according to an embodiment.

In FIG. 3, at step S310, the parking brake release apparatus 100 of a double-parked vehicle may receive the request for the parking brake release of the parked vehicle.

The parking brake release apparatus 100 of a double-parked vehicle may collect the vehicle information of the parked vehicle based on the input vehicle number when the vehicle number of the parked vehicle is input through an application of a user terminal.

The parking brake release apparatus 100 of a double-parked vehicle may specify the owner of the parked vehicle based on the vehicle information and provide a notification with respect to the request for the parking brake release to the owner terminal.

At step S320, the parking brake release apparatus 100 of a double-parked vehicle may determination whether the parking brake release is permitted.

The parking brake release apparatus 100 of a double-parked vehicle may check whether the parked vehicle is turned off, whether all doors are locked up, whether the parking brake is in a predetermined state, and whether there is no person inside the vehicle.

The parking brake release apparatus 100 of a double-parked vehicle may determine whether the parked vehicle is parked on a flat surface or a sloped surface by using a tilt sensor attached to the parked vehicle.

The parking brake release apparatus 100 of a double-parked vehicle may determine whether the parked vehicle is parked on a flat surface or a sloped surface by combining an accelerometer and a gyroscope.

The parking brake release apparatus 100 of a double-parked vehicle may determine that the parking brake release is not permitted when it is determined that the parked vehicle is parked on sloped surface.

When the parked vehicle is parked on a flat surface, the parking brake release apparatus 100 of a double-parked vehicle may check whether the parked position of the parked vehicle is in a double parking area of a parking lot.

The parking brake release apparatus 100 of a double-parked vehicle may detect a person or object within a certain range of surroundings of the parked vehicle.

When the parked position is in a double parking area and a person or object is not detected within a certain range of surroundings, the parking brake release apparatus 100 of a double-parked vehicle may determine that the parking brake release is permitted.

At step S330, the parking brake release apparatus 100 of a double-parked vehicle may request the owner of the parked vehicle for the final approval of the parking brake release when the parking brake release is determined to be permitted.

At step S340, the parking brake release apparatus 100 of a double-parked vehicle may remotely release the parking brake of the parked vehicle when the final approval of the owner is received.

When the request for the parking brake release exceeds a reference amount (i.e., a reference value), the parking brake release apparatus 100 of a double-parked vehicle may voluntarily release the parking brake even before the final approval of the owner is received. The parking brake release apparatus 100 of a double-parked vehicle may transmit an alarm with respect to the voluntary release of the parking brake to owner.

FIG. 4 is a drawing for explaining a method of controlling the vehicle when moving the parked vehicle after the parking brake is remotely released and re-engaging the parking brake at the time when a reason for termination of release has occurred.

When the parking brake is released according to the parking brake release method of the parked vehicle so that the gear becomes neutral, the requester or another person may move the parked vehicle by pushing.

For the safety reason, the parking brake release apparatus 100 of a double-parked vehicle may change the tire direction to be straight before the requester pushes the vehicle, and when the vehicle starts to move, may light the hazard light and sound the horn in order to provide notification to the surroundings, and prevent the vehicle from moving when an obstacle is encountered.

In FIG. 4, the parking brake release apparatus 100 of a double-parked vehicle may check whether the parked vehicle is prepared for moving when the parking brake is released.

At step S410, the parking brake release apparatus 100 of a double-parked vehicle may check the tire direction of the parked vehicle, the side mirror position, and whether there exists an obstacle in the moving direction of the parked vehicle when the parking brake is released.

The parking brake release apparatus 100 of a double-parked vehicle may control the vehicle based on a sensor before moving of the parked vehicle when whether the parked vehicle is prepared for moving is not confirmed.

At step S420, the parking brake release apparatus 100 of a double-parked vehicle may be prepared for moving by adjusting the tire direction to be straight by using the steering angle sensor before moving of the parked vehicle, folding an unfolded side mirror, and lighting a hazard light.

When the obstacle is detected, the parking brake release apparatus 100 of a double-parked vehicle may provide an external warning until the obstacle is not detected.

The parking brake release apparatus 100 of a double-parked vehicle may control the parked vehicle based on a sensor during moving of the parked vehicle when whether the parked vehicle is prepared for moving is confirmed.

At step S430, the parking brake release apparatus 100 of a double-parked vehicle may check whether the reason for termination of release has occurred, such as the obstacle being detected within a reference radius during the movement of the parked vehicle, the vehicle speed becoming higher than a particular speed, a particular time having elapsed, or the vehicle having moved by a particular distance.

The parking brake release apparatus 100 of a double-parked vehicle may operate the parking brake again when whether the reason for termination of parking brake release has occurred is confirmed.

At step S440, when the reason for termination of release has occurred, when the parked vehicle has not moved for a preset time or more after the parking brake release, or when an input of the termination of the reason for releasing the parking brake is received from the vehicle owner, the parking brake release apparatus 100 of a double-parked vehicle may operate the parking brake of the parked vehicle again and provide a notification.

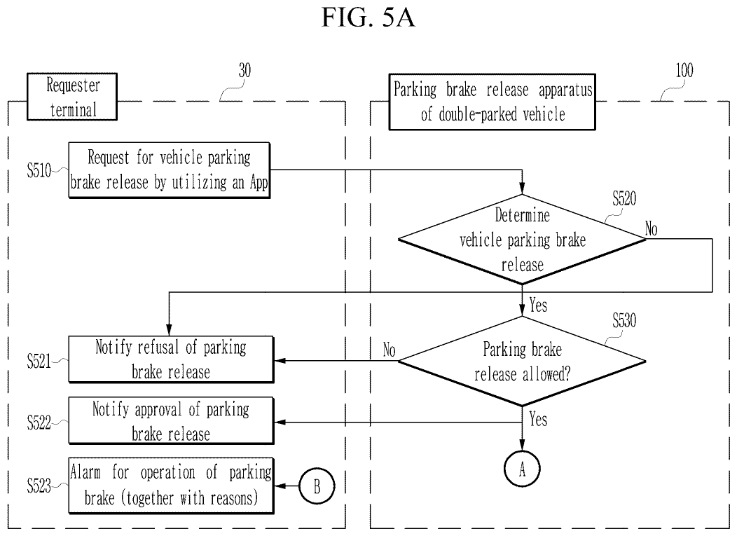

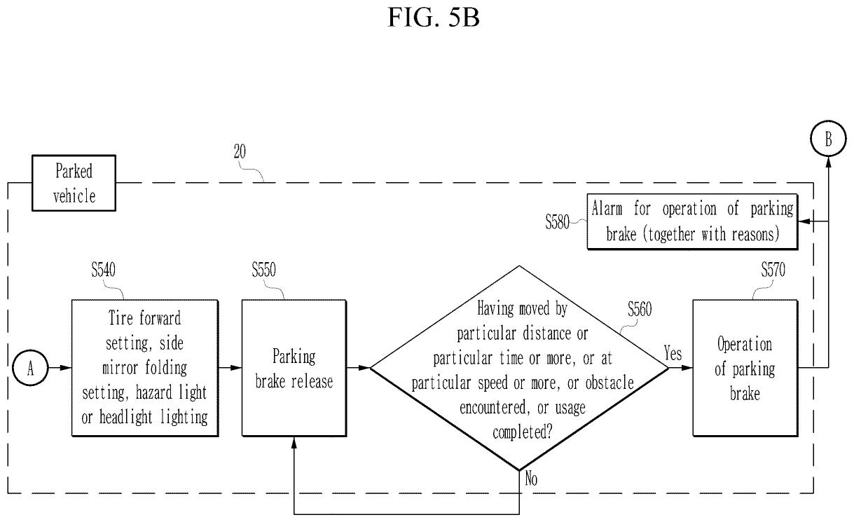

FIG. 5A and FIG. 5B are flowcharts of a parking brake release method of the parked vehicle according to an embodiment.

FIG. 5A and FIG. 5B describes events that may occur according to the parking brake release method of the parked vehicle according to an embodiment, by event occurrence object.

In FIG. 5A and FIG. 5B, at step S510, the requester may request a release of a vehicle parking brake by utilizing an App or application installed in the requester terminal 30.

In other words, when the requester inputs the vehicle number desired for the parking brake release into the Bluelink through the requester terminal 30, the parking brake release apparatus 100 of a double-parked vehicle may find the vehicle of that vehicle number, confirm the vehicle number, and thereby confirm the vehicle information of the parked vehicle 20.

At step S520, the parking brake release apparatus 100 of a double-parked vehicle may determine whether the vehicle parking brake release is permitted.

At step S530, when the release is impossible (No at step S530), the parking brake release apparatus 100 of a double-parked vehicle may provide an alarm for refusal of the parking brake release to the requester terminal, and may allow the parking brake release when the release is permitted (Yes at step S530).

Even when the release is permitted, the parking brake release apparatus 100 of a double-parked vehicle may refuse the release when there is not the final approval of the vehicle owner or the like.

At step S521, the requester terminal 30 may provide the alarm for refusal of the parking brake release received from the parking brake release apparatus 100 of a double-parked vehicle to the requester.

When the parking brake release is approved, the requester terminal 30 may provide the notification for the approval of the parking brake release, at step S522.

After the allowance of the parking brake release of the parking brake release apparatus 100 of a double-parked vehicle, the parked vehicle 20 may perform the tire forward setting, the side mirror folding setting, and the hazard light (or headlight) lighting setting, at step S540.

At step S550, the parked vehicle 20 may release the parking brake according to the control of the parking brake release apparatus 100 of a double-parked vehicle.

At step S560, the parking brake release apparatus 100 of a double-parked vehicle determines whether a reason for termination of release or a reason for finishing vehicle usage occurs, which includes detecting of the obstacle within a reference radius with respect to the parked vehicle 20, the vehicle speed becoming higher than a particular speed, elapsing of a particular time, or the vehicle's having moved by a particular distance.

When none of the reasons occurs (No at step S560), the parking brake release apparatus 100 of a double-parked vehicle may maintain the parking brake release state, and when any of the reasons occurs (Yes at step S560), the parking brake of the parked vehicle 20 may be operated again, at step S570,

At step S580, the parked vehicle 20 may provide the notification with respect to an operation of the parking brake to the vehicle owner and/or the outside together with the reason for re-operation.

At the same time, the requester terminal 30 may be provided with an alarm for an operation of the parking brake together with the reason, at step S523.

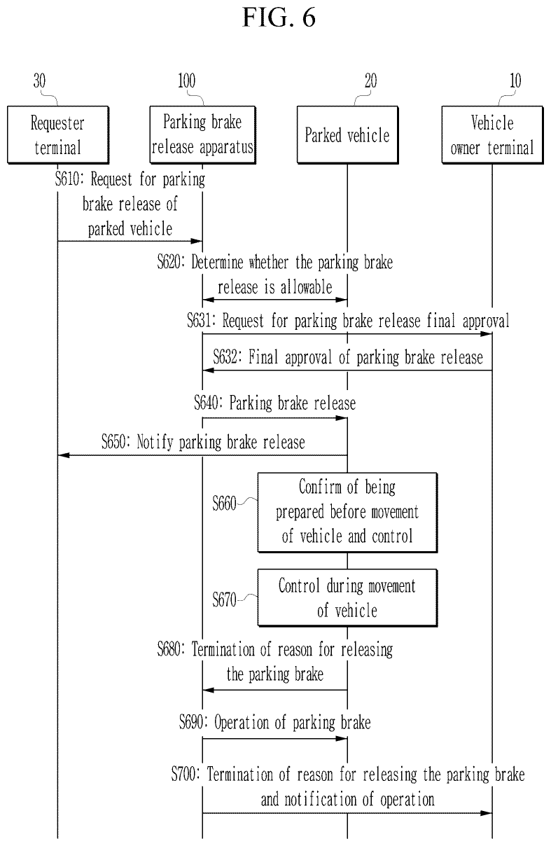

FIG. 6 is a signal flowchart of a parking brake release system of the parked vehicle according to an embodiment.

FIG. 6 shows the flow of signals exchanged between the vehicle owner terminal 10, the parked vehicle 20, the requester terminal 30, and the parking brake release apparatus 100.

In FIG. 6, at step S610, the requester terminal 30 may request the parking brake release apparatus 100 of the double-parked vehicle for the parking brake release of the parked vehicle.

At step S620, the parking brake release apparatus 100 may determine whether the parking brake release is permitted through signal exchange with the parked vehicle 20.

When the parking brake whether the release is permitted is determined, the parking brake release apparatus 100 may request the parking brake release final approval from the vehicle owner terminal 10, at step S631.

When the input of the final approval by the vehicle owner is provided through an application or the like, the vehicle owner terminal 10 may transfer the signal of the parking brake release final approval to the parking brake release apparatus 100, at step S632.

At step S640, the parking brake release apparatus 100 may remotely release the parking brake of the parked vehicle 20.

At step S650, the parked vehicle 20 may provide the notification for the parking brake release to the requester terminal 30.

At step S660, the parked vehicle 20 may check the tire direction before the movement of the vehicle through sensors after the parking brake release, check the side mirror position, and check whether there exists an obstacle in the moving direction.

When the parked vehicle 20 is not confirmed to be prepared for moving, the parking brake release apparatus 100 may adjust the tire direction to be straight through the control of the parked vehicle 20, fold an unfolded side mirror, and provide an external warning until the obstacle is not detected.

When confirmed to be prepared for moving, the parked vehicle 20 may light a hazard light to notify the requester of being prepared for moving.

When being prepared for moving is confirmed, the parked vehicle 20 may provide the notification of confirmation of the vehicle's being prepared for moving to the requester terminal 30.

At step S670, the parked vehicle 20 may perform the control during the movement based on sensors.

For example, when an obstacle is detected within a reference radius during the movement, the parked vehicle 20 may operate the parking brake again, and when the vehicle speed of the parked vehicle becomes higher than a particular speed during the movement, operate the parking brake again, and when a predetermined particular time has elapsed or the vehicle has moved by a predetermined particular distance during the movement, may operate the parking brake again.

When the reason for releasing the parking brake is terminated, the parked vehicle 20 notifies it to the parking brake release apparatus at step S680. The termination of the reason for releasing the parking brake may correspond to the case of receiving the termination from the requester terminal 30, or the case that it is determined that at least one among a plurality of predetermined release reasons has occurred.

When a signal for termination of the reason for release is received, the parking brake release apparatus 100 may operate the parking brake of the parked vehicle 20. at step S690,

At step S700, the parking brake release apparatus 100 may provide a notification to the vehicle owner terminal 10 with respect to the termination of the reason for releasing the parking brake and operation of the parked vehicle 20.

FIG. 7 is a drawing for explaining a computing device according to an embodiment.

Referring to FIG. 7, the parking brake release apparatus of the double-parked vehicle and method according to embodiments may be implemented by using the computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 6.

The memory 930 and the storage device 960 may include various types of volatile or non-volatile storage media. For example, the memory may include a read-only memory (ROM) 931 and random-access memory (RAM) 932. In an embodiment, the memory 930 may be located inside or outside processor 910, and the memory 930 may be connected to the processor 910 through various known means.

In some embodiments, at least some configurations or functions of a parking brake release apparatus and method for a double-parked vehicle according to an embodiment may be implemented as a program or software executable by the computing device 900, and program or software may be stored in a computer-readable medium.

In some embodiments, at least some components or functions of a parking brake release apparatus and method for a double-parked vehicle according to one or more embodiments may be implemented using hardware or circuit of the computing device 900 or may be implemented as separate hardware or circuit that may be electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A parking brake release method, comprising:
receiving a request for a parking brake release of a vehicle;
determining whether the parking brake release is permitted;
requesting an owner of thing vehicle for a final approval of the parking brake release based on the parking brake release being determined to be permitted; and
remotely releasing the parking brake of the vehicle based on a receipt of the final approval of the owner.

2. The parking brake release method of claim 1, further comprising determining whether the vehicle is prepared for moving based on the parking brake being released,
wherein determining whether the vehicle is prepared for moving comprises:
determining a tire direction of the vehicle;
determining a side mirror position of the vehicle; and
determining whether there exists obstacle in a moving direction of the vehicle.

3. The parking brake release method of claim 2, further comprising controlling the vehicle based on a sensor before moving of the vehicle, based on a condition that whether the vehicle is prepared for moving is not confirmed,
wherein controlling the vehicle based on the sensor before moving of the vehicle comprises:
adjusting the tire direction to be straight by using a steering angle sensor;
folding an unfolded side mirror;
providing an external warning until the obstacle is not detected; and
lighting a hazard light based on confirmation that the vehicle is prepared for moving.

4. The parking brake release method of claim 3, further comprising controlling the vehicle based on the sensor during moving of the vehicle, based on a condition that whether the vehicle is prepared for moving is confirmed,
wherein controlling the vehicle based on the sensor during moving of the vehicle comprises:
operating the parking brake again based on the obstacle being detected within a reference radius during movement of the vehicle;
operating the parking brake again based on a vehicle speed of the vehicle being higher than a predetermined speed during the movement of the vehicle; and
operating the parking brake again based on a predetermined time having elapsed or the vehicle having moved by a predetermined distance during the movement of the vehicle.

5. The parking brake release method of claim 1, wherein receiving the parking brake release request comprises:
collecting vehicle information of the vehicle based on a vehicle number of the vehicle being input through an application of a user terminal;
specifying the owner of the vehicle based on the vehicle information; and
providing a notification on a request for the parking brake release to a terminal of the owner.

6. The parking brake release method of claim 1, wherein determining whether the parking brake release is permitted comprises:
determining whether the vehicle is turned off;
determining whether all doors are locked up;
determining whether the parking brake is in a predetermined state; and
determining whether there is no person inside the vehicle.

7. The parking brake release method of claim 1, wherein determining whether the parking brake release is permitted comprises:
determining whether the vehicle is parked on a flat surface or a sloped surface by using a tilt sensor attached to the vehicle; and
determining that the parking brake release is not permitted, based on a determination that the vehicle is parked on the sloped surface.

8. The parking brake release method of claim 1, wherein determining whether the parking brake release is permitted comprises:
determining whether a parked position of the vehicle is in a double parking area of a parking lot;
detecting a person or an object within a predetermined range of surroundings of the vehicle; and
determining that the parking brake release is permitted based on the parked position being in a double parking area and the person or the object being not detected within the predetermined range of surroundings.

9. The parking brake release method of claim 1, wherein remotely releasing the parking brake of the vehicle based on the receipt of the final approval of the owner comprises:
voluntarily releasing the parking brake before the final approval of the owner is received; and
transmitting an alarm with respect to the voluntary release of the parking brake to the owner based on one or more requests for the parking brake release exceeding a reference value.

10. The parking brake release method of claim 1, further comprising:
operating the parking brake of the vehicle again based on the vehicle having not moved for a preset time or more after the parking brake release of the vehicle, or an input of a termination of a reason for releasing the parking brake being received from the owner; and
providing a notification for the termination of the reason for releasing the parking brake.

11. An apparatus for remotely releasing a parking brake, the apparatus comprising:
one or more memory devices storing program codes; and
one or more processors configured to perform, by execute the program,
receiving a request for a parking brake release of a vehicle,
determining whether the parking brake release is permitted,
requesting an owner of the vehicle for a final approval of the parking brake release based on the parking brake release being determined to be permitted, and
remotely releasing the parking brake of the vehicle based on a receipt of the final approval of the owner.

12. The apparatus of claim 11, wherein the one or more processors is further configured to perform determining whether the vehicle is prepared for moving based on the parking brake being released,
wherein the determining whether the vehicle is prepared for moving comprises:
determining a tire direction of the vehicle;
determining a side mirror position of the vehicle; and
determining whether there exists obstacle in a moving direction of the vehicle.

13. The apparatus of claim 12, wherein the one or more processors is further configured to perform controlling the vehicle based on a sensor before moving of the vehicle, based on a condition that whether the vehicle is prepared for moving is not confirmed,
wherein controlling the vehicle based on the sensor before moving of the vehicle comprises:
adjusting the tire direction to be straight by using a steering angle sensor;
folding an unfolded side mirror;
providing an external warning until the obstacle is not detected; and
lighting a hazard light based on confirmation that the vehicle is prepared for moving.

14. The apparatus of claim 13, wherein the one or more processors is further configured to perform controlling the vehicle based on the sensor during moving of the vehicle, based on a condition that whether the vehicle is prepared for moving is confirmed,
wherein controlling the vehicle based on the sensor during moving of the vehicle comprises:
operating the parking brake again based on the obstacle being detected within a reference radius during movement of the vehicle;
operating the parking brake again based on a vehicle speed of the vehicle being higher than a predetermined speed during the movement of the vehicle; and
operating the parking brake again based on a predetermined time having elapsed or the vehicle having moved by a predetermined distance during the movement of the vehicle.

15. The apparatus of claim 11, wherein receiving the parking brake release request comprises:
collecting vehicle information of the vehicle based on a vehicle number of the vehicle being input through an application of a user terminal;
specifying the owner of the vehicle based on the vehicle information; and
providing a notification on a request for the parking brake release to a terminal of the owner.

16. The apparatus of claim 11, wherein determining whether the parking brake release is permitted comprises:
determining whether the vehicle is turned off;
determining whether all doors are locked up;
determining whether the parking brake is in a predetermined state; and
determining whether there is no person inside the vehicle.

17. The apparatus of claim 1, wherein determining whether the parking brake release is permitted comprises:
determining whether the vehicle is parked on a flat surface or a sloped surface by using a tilt sensor attached to the vehicle; and
determining that the parking brake release is not permitted based on a determination that the vehicle is parked on the sloped surface.

18. The apparatus of claim 1, wherein determining whether the parking brake release is permitted comprises:
determining whether a parked position of the vehicle is in a double parking area of a parking lot by using a GPS, a camera, a radar, a lidar or an ultrasonic wave sensor attached to the vehicle;
sensing a person or an object within a predetermined range of surroundings of the vehicle by using the camera, the radar, the lidar or the ultrasonic wave sensor; and
determining that the parking brake release is permitted based on the parked position being in a double parking area and the person or the object being not detected within the predetermined range of surroundings.

19. The apparatus of claim 11, wherein remotely releasing the parking brake of the vehicle based on the receipt of the final approval of the owner comprises:
voluntarily releasing the parking brake before the final approval of the owner is received; and
transmitting an alarm with respect to the voluntary release of the parking brake to the owner based on one or more requests for the parking brake release exceeding a reference value.

20. The apparatus of claim 11, wherein the one or more processors is further configured to perform:
operating the parking brake of the vehicle again based on the vehicle having not moved for a preset time or more after the parking brake release of the vehicle, or an input of a termination of a reason for releasing the parking brake being received from the owner; and
providing a notification for the termination of the reason for releasing the parking brake to the owner and the outside.
